(19) United States
(12) Patent Application Publication
(10) Pub. No.: US 2009/0059562 A1
(43) Pub. Date: Mar. 5, 2009

(54) BACKLIGHT UNIT AND LAMP FOR BACKLIGHT UNIT

(76) Inventors: Takashi Maniwa, Osaka (JP); Hirofumi Yamashita, Osaka (JP); Kazuhiro Kumada, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 11/909,067

(22) PCT Filed: Mar. 29, 2006
(86) PCT No.: PCT/JP2006/306559

§ 371 Date: Sep. 18, 2007

(30) Foreign Application Priority Data
Apr. 20, 2005 (JP) 2005-122746

(51) Int. Cl. G09F 13/08

(52) U.S. Cl. 362/97.1

(57) ABSTRACT

The present invention is a backlight unit 1 in which multiple substantially U-shaped lamps, to each of whose respective both end portions 11a and 11b an electrode 12 is attached, are disposed in parallel to one another in an envelope 20 in a manner that the end portions 11a and 11b of each lamp 10 face opposite to the end portions 11a and 11b of the adjacent lamp 10 and are positioned closer to a side wall 42/44 of the envelope 20 than a bent portion 13 of the adjacent lamp 10 is. Herewith, it is possible to offer the backlight unit 1 realizing reduced unevenness in luminance and requiring less power consumption.

### TECHNICAL FIELD

The present invention relates to a backlight unit having multiple lamps each formed in a substantial U-shape and a substantially U-shaped lamp for a backlight unit.

### BACKGROUND ART

Direct type backlight units that have multiple lamps each bent in a substantial U-shape as light source are used, for example, in LCD (liquid crystal display) apparatuses. The reason that substantially U-shaped lamps have been adopted in backlight units is because the number of lamps required can be reduced by half as compared to the case where straight lamps are used, which leads to an improvement in the lamp installation efficiency.

In common backlight units, substantially U-shaped lamps are arranged in parallel to each other in an envelope in a manner that the end portions of all the lamps are positioned on the same side, either left or right. However, the end portions being disposed on a single side means the concentration of the electrodes on the side. Since the electrodes are the source of heat generation, a difference in temperature is produced between the left and right sides of the envelope. The temperature difference affects the mercury vapor pressure of the lamps and accordingly induces unevenness of luminance in the backlight unit.

Regarding this issue, Patent Reference 1 discloses a backlight unit 100 in which end portions 111a and 111b of each curved lamp 110 face opposite to end portions 111a and 111b of the adjacent curved lamp 110, as shown in FIG. 9, so that the temperature within an envelope 120 is maintained uniformly over the left and right sides, whereby reducing the unevenness in luminance.

In the envelope 120 of the backlight unit 100, rubber holders 180 are provided on the left and right sides. Here, the lamps 110 are installed with the end portions 111a and 111b inserted into insertion holes 181 of the holders 180 and bent portions 113 of the lamps 110 fitted into engaging grooves 182 of the holders 180. In FIG. 9, the part enclosed by the two-dot chain line is a light take-out region 121 of the envelope 120.

<Patent Reference 1> Japanese Laid-Open Patent Application No. 2004-327328

### DISCLOSURE OF THE INVENTION

### Problems that the Invention is to Solve

With the backlight unit 100, however, light emitted from the bent portions 113 cannot be efficiently taken out from the envelope 120 because the bent portions 113 are positioned outside the light take-out region 121, and accordingly electric power for operating the bent portions 113 is wasted.

However, if the light take-out region 121 is expanded in width so as to include the bent portions 113 therein, the end portions 111a and 111b hardly emitting light are also included in the light take-out region 121. As a result, dark regions due to the end portions 111a and 111b are extensively formed in the light take-out region 121.

In general, the backlight unit 100 is designed so that luminance is uniformly distributed over bright regions that emit light and dark regions that hardly emit light, using a translucent plate (not shown). However, the dark regions formed due to the end portions 111a and 111b are actually so extensive that the translucent plate is ineffectual to distribute the luminance uniformly. As a result, the dark regions still remain, causing unevenness in luminance.

In view of the above issues, the present invention aims to provide a backlight unit realizing reduced unevenness in luminance and requiring less power consumption.

### Means to Solve the Problem

In order to solve the above problems, the backlight unit of the present invention is characterized in that a plurality of substantially U-shaped lamps, each including two end portions and a bent portion, are disposed in parallel to one another in an envelope in a manner that the end portions of each of the lamps face opposite to the end portions of an adjacent one of the lamps. Here, electrodes are respectively attached to each of the end portions. The end portions of each of the lamps are positioned closer to a side wall of the envelope than the bent portion of the adjacent one of the lamps is.

In addition, the backlight unit of the present invention is characterized in that the bent portion of each of the lamps is positioned within a light take-out region of the envelope, and the end portions of each of the lamps may be positioned outside the light take-out region.

Furthermore, the backlight unit of the present invention is characterized in that the end portions and the electrodes of each of the lamps are housed in a socket positioned outside the light take-out region.

Furthermore, the backlight unit of the present invention is characterized in that part of each of the lamps, which has a less than 70% relative luminance to the bent portion, is positioned outside the light take-out region.

Furthermore, the backlight unit of the present invention is characterized by including a supporting member operable to support the lamps in the envelope. Here, a reflection layer for reflecting light from the lamps toward a light take-out opening of the envelope is positioned at part of the supporting member, which is in contact with the lamps.

The substantially U-shaped lamp for a backlight unit of the present invention is characterized in that, in the backlight unit, a plurality of substantially U-shaped lamps, each including two end portions and a bent portion, are disposed in parallel to one another in an envelope of the backlight unit in a manner that the end portions of each of the lamps face opposite to the end portions of an adjacent one of the lamps and are positioned closer to a side wall of the envelope than the bent portion of the adjacent one of the lamps is. An electrode is attached to each of the end portions. Here, A−W+3≦L≦A−W/3+3 is satisfied, where A [mm] is an extent of a light take-out region of the backlight unit in a direction perpendicular to a direction in which the lamps are disposed in parallel to one another, W [mm] is a space between paired straight tube portions of each of the lamps, and L [mm] is a distance from a tip of the electrode to an edge of the bent portion in the perpendicular direction.

### ADVANTAGEOUS EFFECTS OF THE INVENTION

According to the backlight unit of the present invention, since both end portions of each lamp are positioned closer to the side wall of the envelope than the bent portion of the adjacent lamp is, it is easy to dispose the bent portion, which emits light, within the light take-out region while disposing the paired end portions, which emit no light, outside the light take-out region. As a result, the backlight unit of the present invention readily facilitates a reduction in power consumption, efficiently using the light emitting parts to the fullest extent. In addition, extensive dark regions are less likely to be formed over the light take-out region, and consequently unevenness in luminance is less likely to occur.

Particularly, in the case where the bent portion of each lamp is disposed within the light take-out region and the end portions are disposed outside the light take-out region, the light emitting parts of each lamp can be efficiently used, whereby realizing a further reduction in power consumption and therefore further reducing the unevenness in luminance.

In addition, in the case where both end portions and electrodes of each lamp are housed in a socket provided outside the light take-out region, extensive dark regions hardly emitting light are less likely to be formed, and consequently unevenness in luminance is further less likely to occur.

Unevenness in luminance caused by parts having a less than 70% relative luminance to the bent portion is difficult to suppress with the use of a translucent plate. Therefore, in the case where such parts are disposed outside the light take-out region, unevenness in luminance is significantly less likely to occur.

In addition, in the case where the backlight unit includes a supporting member, on which a reflection layer for reflecting light from the lamps toward the light take-out opening of the envelope is formed, light emitted from the lamps are efficiently taken out even if the supporting member is positioned within the light take-out region.

The substantially U-shaped lamp for a backlight unit of the present invention satisfies A−W+3≦L≦A−W/3+3, where A [mm] is an extent of a light take-out region of the backlight unit in the direction perpendicular to the direction in which the lamps are disposed in parallel to one another, W [mm] is a space between paired straight tube portions of each of the lamps, and L [mm] is a distance from a tip of the electrode to an edge of the bent portion in the perpendicular direction. As a result, when the lamp is installed in the envelope of a backlight unit, light emitted from the lamp can be efficiently taken out from the light take-out opening of the envelope.

### BRIEF DESCRIPTION OF THE DRAWINGS

FIG. 1 is an exploded perspective view showing a schematic structure of a backlight unit of an embodiment;

FIG. 2 is a plane view of the backlight unit with a mounting frame and a translucent plate detached therefrom;

FIG. 3 is a cross-section view along the line A-A of FIG. 2;

FIG. 4 is a partially cutaway plane view showing a schematic structure of a lamp;

FIG. 5 is a perspective view showing a bush attached to the lamp;

FIG. 6 is an enlarged view of a part of the backlight unit;

FIG. 7 shows a relationship between relative luminance and distance from a tip of a glass bulb;

FIG. 8 shows a relationship between lamp power and Dimension D3, the distance from a bent portion to an edge of a light take-out region; and

FIG. 9 is a plane view of a conventional backlight unit with a mounting frame and a translucent plate detached therefrom.

### EXPLANATION OF REFERENCES

1 backlight unit
10 lamp
11a, 11b end portion
12 electrode
13 bent portion
15 glass bulb
20 envelope
21 light take-out region
51 light take-out opening
80 supporting member
83 reflection layer

### BEST MODE FOR CARRYING OUT THE INVENTION

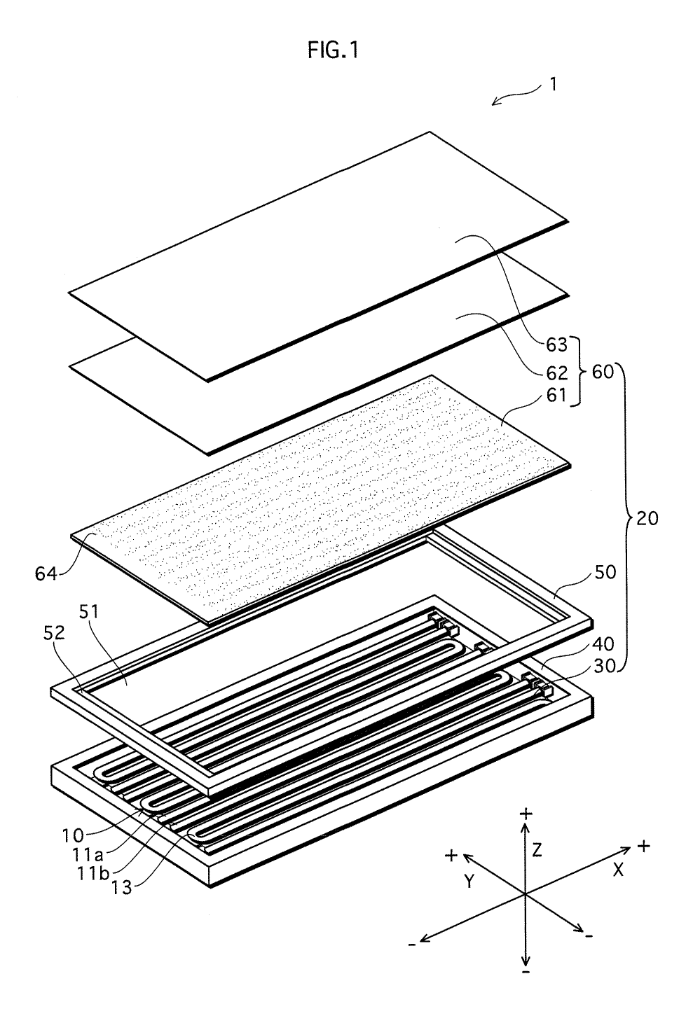

FIG. 1 is an exploded perspective view showing a schematic structure of a backlight unit of the present embodiment. A backlight unit 1 of the present embodiment is for use in LCD apparatuses, and is disposed on the back side of the LCD panel (not shown). The X axis in FIG. 1 represents the right-and-left direction of the backlight unit 1 (+: right, −: left); the Y axis represents the up-and-down direction (+: up, −: down); and the Z axis represents the front-and-back direction (+: front side, i.e. LCD panel side, −: back side).

The backlight unit 1 includes multiple cold cathode fluorescent lamps 10 (hereinafter, simply referred to as the “lamps 10”) each formed in a substantial U-shape. Each lamp 10 has paired end portions 11a and 11b, to each of which an electrode 12 is provided, and a bent portion 13 on the opposite side to the paired end portions 11a and 11b. Here, the lamp in a substantial U-shape means a lamp having the paired end portions 11a and 11b on one side and the bent portion 13 on the other. The bent portion may be formed in a circular arc shape with a single corner, or may have two substantially perpendicular corners with a straight in between. Note that a lamp having a glass bulb which is formed by bridge-connecting two straight glass tubes at one end of these respective tubes is one type of the substantially U-shaped lamps.

All lamps 10 are arranged inside an envelope 20, aligning in parallel to each other in the up-and-down direction with the both end portions 11a and 11b of each lamp 10 facing opposite to the end portions 11a and 11b of the adjacent lamp 10. The envelope 20 includes a reflecting plate 30, a side plate 40, a mounting frame 50 and a translucent plate 60.

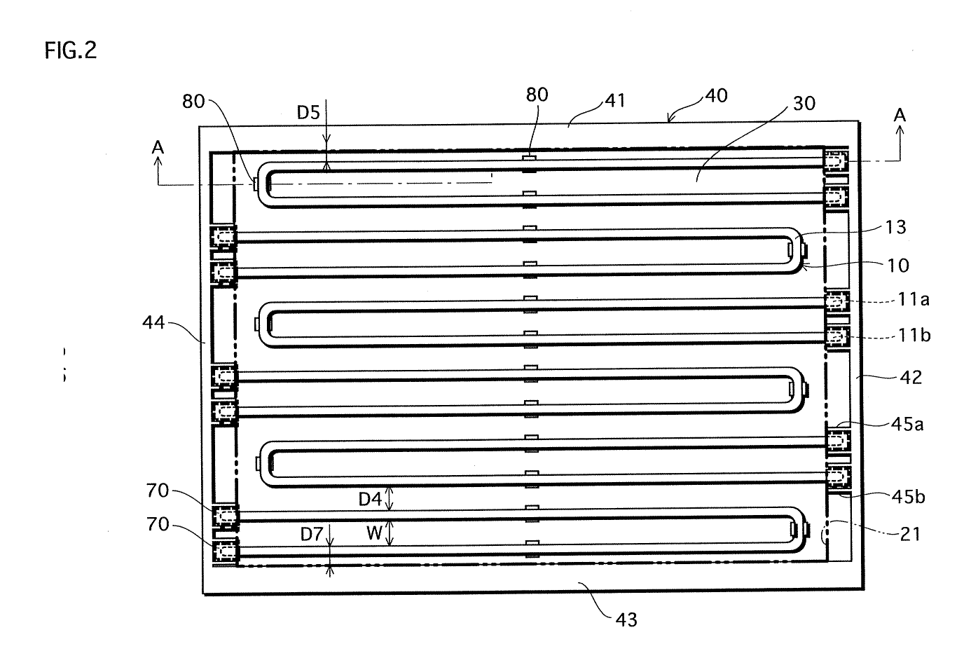

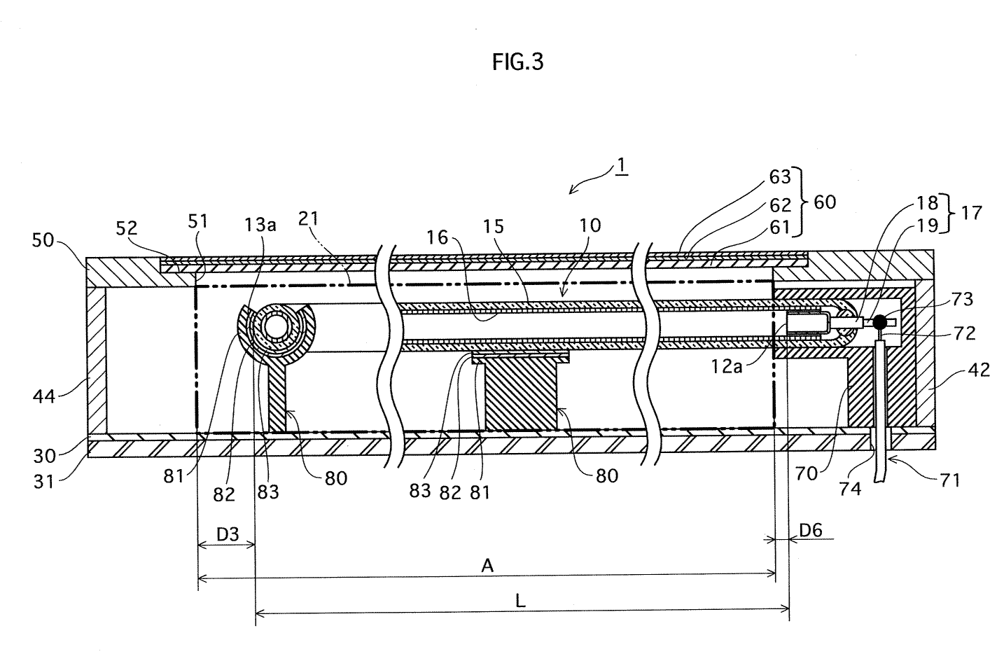

FIG. 2 is a plane view of the backlight unit with the mounting frame and translucent plate detached therefrom. FIG. 3 is a cross-section view along the line A-A of FIG. 2.

The reflecting plate 30 is a square board made of PET (polyethylene terephthalate) resin, and is disposed on the back side of the lamps 10, as shown in FIG. 2. In addition, a metal reinforcing plate 31 is attached to the back side of the reflecting plate 30, as shown in FIG. 3.

Now referring back to FIG. 2, the side plate 40 is composed of an upper side member 41, a right side member 42, a lower side member 43 and a left hand member 44 that are provided so as to surround the set of the lamps 10 along the edges of the reflecting plate 30. On a surface of each right and left side members 42 and 44 facing one another, multiple chip-holding pieces 45a and 45b, each made up of a pair of members, are provided at predetermined intervals. These chip-holding pieces 45a and 45b are used for fixing bushes 70 that function as sockets and are attached to the end portions 11a and 11b of the lamps 10. Note that the chip-holding pieces 45a and 45b and bushes 70 are explained later.

As shown in FIG. 1, the mounting frame 50 is, for example, an open square frame made of an opaque material and has a square opening 51 from which light is taken out. On the surface of the mounting frame 50, depressed edges 52 whose extent is comparatively larger than the opening 51 are formed, and the translucent plate 60 is fitted into the depressed edges 52 to cover the opening 51. Note that the mounting frame 50 is not limited to the open square frame, and may be, for instance, a pair of L-shaped or U-shaped mounting frames which are assembled to form an open square configuration.

The translucent plate 60 is formed by layering a diffuser plate 61, a diffuser sheet 62 and a lens sheet 63 in the stated order from the back side. The diffuser plate 61 is a square board made of PC (polycarbonate) resin. The diffuser sheet 62 is a sheet also made of PC resin. The lens sheet 63 is an acrylic resin sheet. On the diffuser plate 61, a dot pattern 64 is provided according to the arrangement of the lamps 10—more specifically speaking, according to the contour of the respective lamps 10 that align in parallel to one another with the end portions of each lamp 10 facing opposite to the end portions of the adjacent lamp 10. Accordingly, light emitted from the lamps 10 is diffused when passing through the diffuser plate 61, and then uniformly emitted from the entire surface of the diffuser plate 61.

Since the mounting frame 50 is made of an opaque material, light inside the envelope 20 has to pass through the opening 51 to go out to the front side of the envelope 20. The part enclosed by the two-dot chain line in FIG. 2 is a light take-out region 21 of the envelope 20. When viewed from the front side of the envelope 20, the position of the light take-out region 21 coincides with that of the opening 51.

As shown in FIG. 2, the upper edge of the opening 51 substantially coincides with the inner edge of the upper side member 41 of the side plate 40. The lower edge of the opening 51 substantially coincides with the inner edge of the lower side member 43 of the side plate 40.

In addition, the right-hand edge of the opening 51 substantially coincides with the edge, facing inward of the envelope 20, of the clip-holding pieces 45a and 45b provided on the right side member 42 of the side plate 40. Also, the right-hand edge of the opening 51 substantially coincides with the edge, facing inward of the envelope 20, of the bush 70 disposed between the clip-holding pieces 45a and 45b provided on the right side member 42 of the side plate 40. The left-hand edge of the opening 51 substantially coincides with the edge, facing inward of the envelope 20, of the clip-holding pieces 45a and 45b provided on the left side member 44 of the side plate 40. Also, the left-hand edge of the opening 51 substantially coincides with the edge, facing inward of the envelope 20, of the bush 70 disposed between the clip-holding pieces 45a and 45b provided on the left side member 44 of the side plate 40.

When viewed from the upper or lower side of the envelope 20, the light take-out region 21 is the part enclosed by the two-dot chain line in FIG. 3. Dimension A of the light take-out region 21 in the left-and-right direction (i.e. the direction perpendicular to the direction in which the lamps 10 are laid in parallel to each other) is 426 mm. In order to take out light in a straight line from the inside of the envelope 20 to the front side, parts emitting light must be disposed within the light take-out region 21. In other words, disposing the parts emitting light outside the light take-out region 21 leads to significant inefficiency in light take-out.

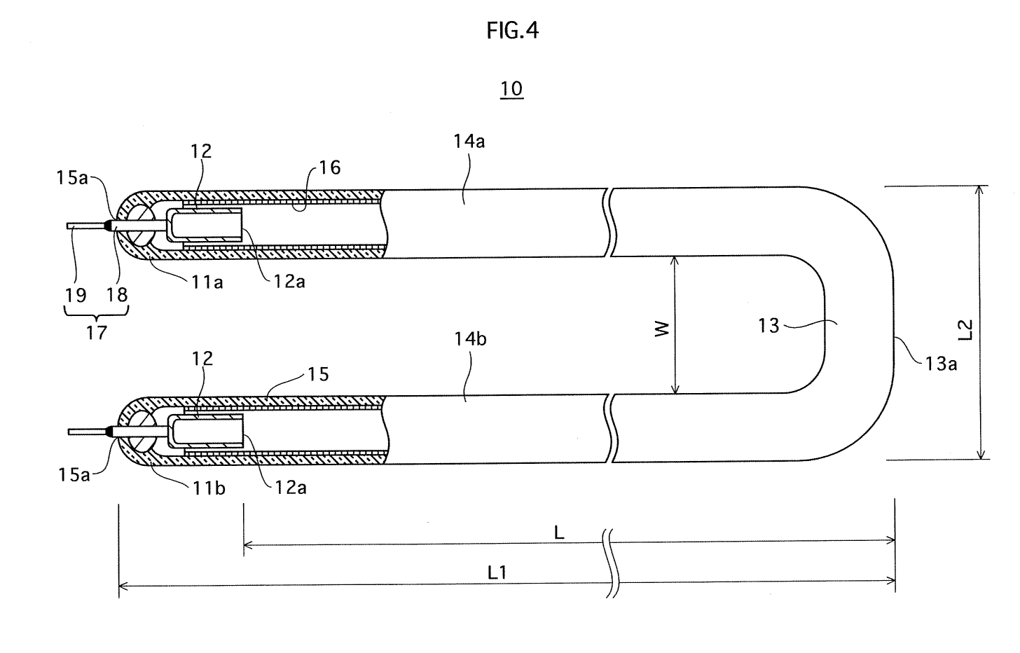

FIG. 4 is a partially cutaway plane view showing a schematic structure of the lamp. As shown in FIG. 4, the lamp 10 has Dimension L1 of 414 mm in total length (the length from a tip 15a of a glass bulb 15 to an edge 13a of the bent portion 13 in the left-and-right direction of the lamp 10—i.e. the direction perpendicular to the direction in which the lamps 10 are arranged in parallel to each other). Dimension L2, the length of the bent portion 13, is 28 mm. Dimension W, the space between straight tube portions 14a and 14b, is 22 mm. The glass bulb 15 of the lamp 10 is made of borosilicate glass (SiO₂—B₂O₃—Al₂O₃—K₂O—TiO₂), and has a substantially circular cross section with 3 mm in outer diameter, 2 mm in inner diameter, and 0.5 mm in tube wall thickness.

Note that each dimension of the lamp 10 is not limited to the above value; however, it is preferable that, for example, Dimension L1 of the total length be in the range of 130 mm to 700 mm and Dimension W of the space between the straight tube portions 14a and 14b be in the range of 9 mm to 33 mm. In addition, each dimension of the glass bulb 15 is not limited to the above value; however, the outer diameter is preferably in the range of 1.8 mm to 6.0 mm (the inner diameter: 1.4 mm to 5.0 mm), for example. Furthermore, the cross section of the glass bulb 15 is not necessary to be substantially circular, and may be a flat-shaped cross section, such as an ellipse.

On the internal surface of the glass bulb 15, a phosphor layer 16 is formed. The phosphor layer 16 is a rare earth phosphor made, for example, of a red phosphor (Y₂O₃:Eu), a green phosphor (LaPO₄:Ce,Tb) and a blue phosphor (BaMg₂Al₁₆O₂₇:Eu,Mn). The glass bulb 15 is filled with approximately 3 mg of mercury (not shown) and a mixed gas of neon and argon (Ne 95%+Ar 5%), as a rare gas, at the gas pressure of 60 Torr.

Note that the phosphor layer 16, mercury, and rare gas are not limited to the above compositions; for instance, a mixed gas of neon and krypton (Ne 95% Kr 5%) may be enclosed as a rare gas. By adopting the mixed gas of neon and krypton as a rare gas, the starting performance of the lamps 10 can be improved and accordingly the lamps 10 can be lit with low voltage.

Onto each end portion 11a/11b of the lamp 10, a lead wire 17 is fixed. The lead wire 17 is a joint wire of an internal tungsten lead wire 18 and an external nickel lead wire 19. The glass bulb 15 is air-tightly sealed, with the lead wire 17 is attached thereto, at the internal lead wire 18. Note that the internal lead wire 18 and the external lead wire 19 respectively have a substantially circular cross section.

To an end of the internal lead wire 18 on the inner side of the glass bulb 15, the electrode 12 is joined by laser welding or the like. The electrode 12 is a so-called hollow electrode in a tubular shape with a bottom, and is fabricated from a niobium (Nb) rod. The electrode 12 is, for example, 5.5 mm in total length, 1.7 mm in outer diameter, 1.5 mm in inner diameter and 0.1 mm in tube wall thickness.

Note that the electrode 12 does not have to be made of niobium, and may be made of nickel (Ni), tantalum (Ta), or molybdenum (Mo), for example. In addition, although the hollow electrode in a tubular shape with a bottom is used as the electrode 12 above, the shape of the electrode is not limited to this. Instead, an electrode in a cylindrical shape or a plate-like electrode in a narrower strip shape may be used. The reason that a hollow electrode has been adopted as the electrode 12 is because it is effective to reduce electrode sputtering caused by discharge during the period when the lamp is lit (for details, see Japanese Laid-Open Patent Application No. 2002-289138).

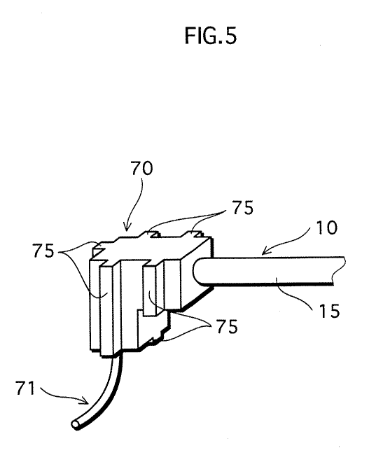

FIG. 5 is a perspective view showing a bush attached to the lamp. As shown in FIG. 5, the bush 70 made of silicon rubber is fitted onto each of the paired end portions 11a and 11b of the lamp 10. That is to say, parts of the lamp 10 housed in the bushes 70 are the paired end portions 11a and 11b. In each bush 70, the lead wire 17 and a covered conductor 71 out of a power supply circuit unit (not shown) are connected as shown in FIG. 3. This connection is made by applying solder 73 to a conductive wire 72 of the covered conductor 71 which is wound around the external lead wire 19. The covered conductor 71 is lead to the outside of the envelope 20 via a continuous hole 74 formed through the reflecting plate 30 and reinforcing plate 31.

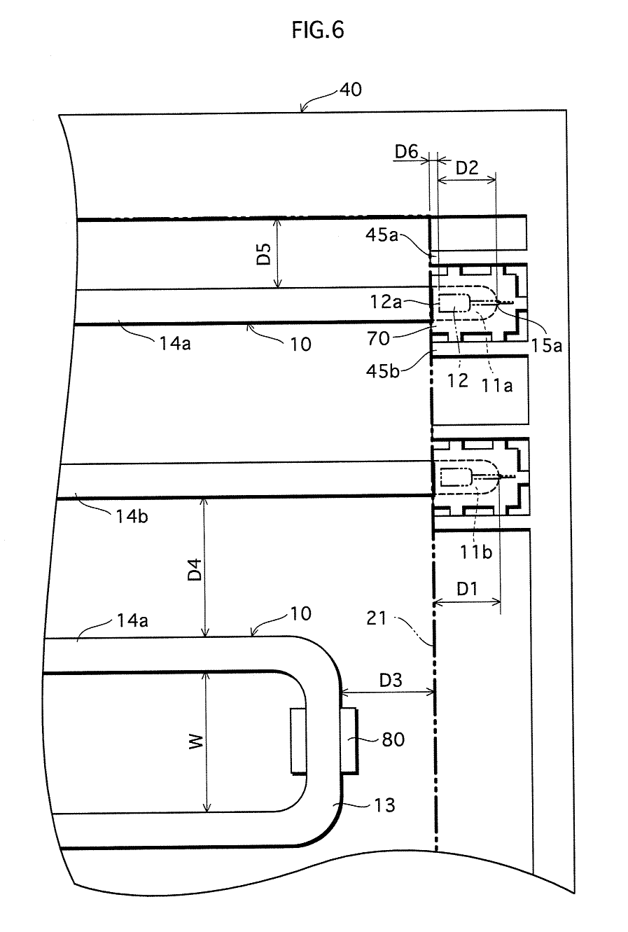

On the outer circumference of the bush 70, multiple ribs 75 are provided in a protruding fashion, as shown in FIG. 5. As shown in FIG. 6, the lamp 10 is attached to the envelope 20 by pressing the bush 70 in between the clip-holding pieces 45a and 45b of the side plate 40. At this point, the bush 70 is elastically deformed, and the lamp is fixed firmly by the restoring force of the bush 70.

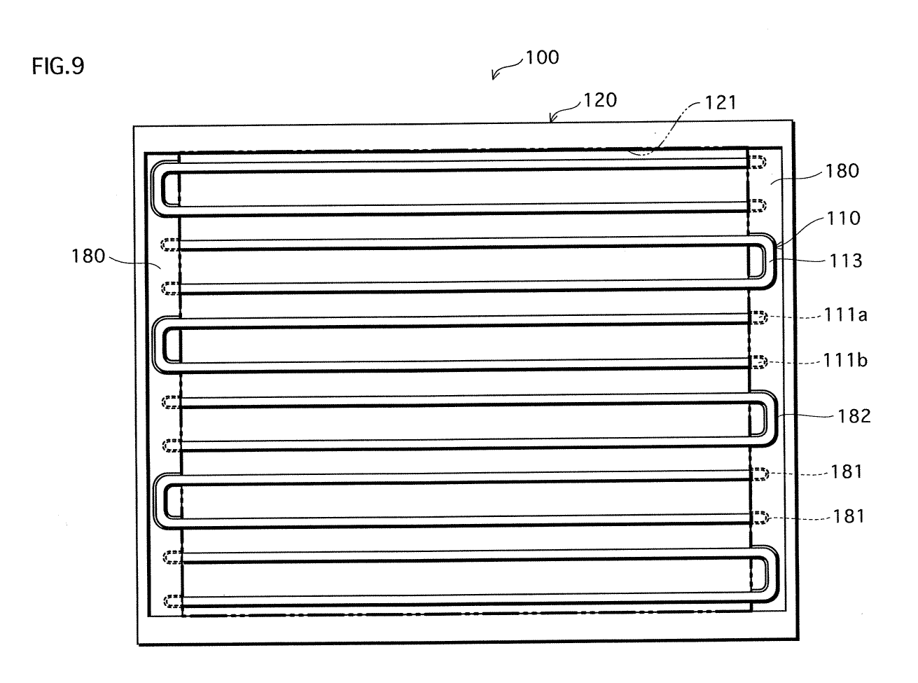

Thus, the bush 70 is attached to each of the end portions 11a and 11b of the lamp 10, and the respective bushes 70 are independent from each other. As a result, the heat of the lamp 10 is less likely to be conducted away therefrom as compared to the case of the conventional backlight unit 100 of FIG. 9, in which all the lamps 110 are fixed by a set of holders 180. The pressed-in bush 70 comes in contact with the side plate 40, reflecting plate 30 and clip-holding pieces 45a and 45b only at the top parts of the ribs 75. Thus, since the contact area is reduced, a less amount of heat is transmitted from the electrode 12 to the envelope 20. Accordingly, the heat generated at the electrode 12 is efficiently used for heating the filler gas, whereby achieving an adequate mercury vapor pressure with less power consumption.

FIG. 6 is an enlarged view of a part of the backlight unit. As shown in FIG. 6, the length of the part of the lamp 10 housed in each bush 70, i.e. Dimension D1 from the tip 15a of the glass bulb 15 to the edge of the bush 70 facing inward of the envelope 20, is 10 mm. Dimension D2, the distance from the tip 15a of the glass bulb 15 to the edge of the electrode 12 facing inward of the envelope 20, is 7 mm. Dimension D6, the distance from the edge of the electrode 12 facing inward of the envelope 20 to the edge of the bush 70 facing inward of the envelope 20, is 3 mm. Accordingly, the entire electrode 12 is housed within the bush 70.

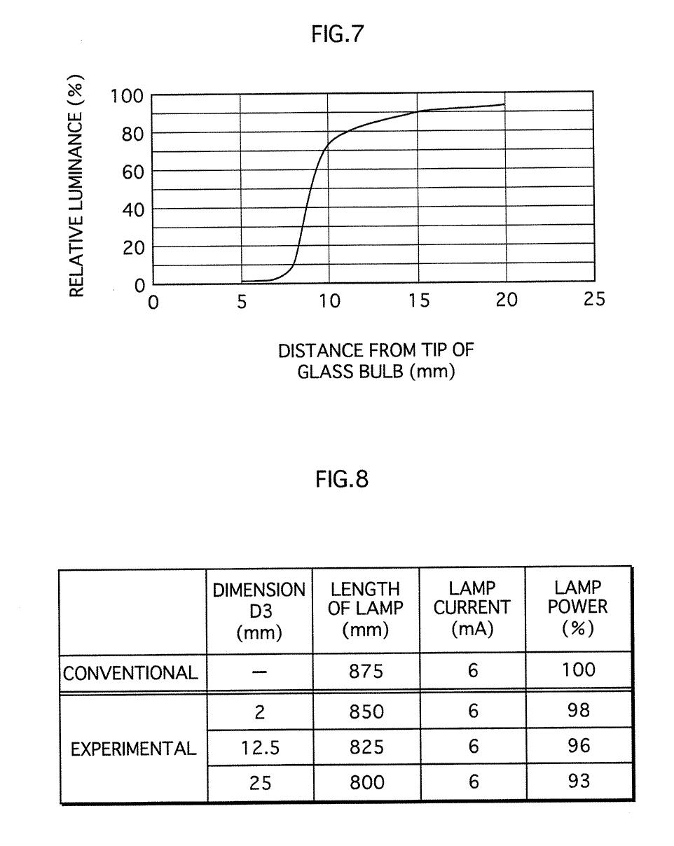

FIG. 7 shows a relationship between distance from the tip of the glass bulb 15 and relative luminance. As shown in FIG. 7, the part from the tip 15a of the glass bulb 15 (0 mm form the tip 15a) to the edge of the electrode 12 facing inward of the envelope 20 (7 mm from the tip 15a) has an approximately 0% relative luminance in relation to the bent portion 13, and thus it can be seen that the part hardly emits light. Accordingly, even if the entire electrode 12 is housed in the bush 70, the light of the lamp 10 will not be wasted.

In addition, when the distance from the tip 15a of the glass bulb 15 is less than 10 mm, the relative luminance falls short of 70%, as shown in FIG. 7. Experiments have determined that, when the part having a relative luminance of less than 70% is disposed within the light take-out region 21, unevenness in luminance cannot be always eliminated by the translucent plate 60. Accordingly, in the present embodiment, Dimension D1 is set to 10 mm in order to dispose the part having a relative luminance of less than 70% outside the light take-out region 21. Herewith, the bush 70 and the entire electrode 12 are also disposed outside the light take-out region 21.

Note that the relative luminance falls short of 50% when the distance from the tip 15a of the glass bulb 15 is less than 8 mm. The part having a relative luminance of less than 50% is a non-light emitting part which is not suitable for the use as a light source, and it is therefore preferably disposed outside the light take-out region 21.

As shown in FIG. 6, Dimension D3, the distance from the bent portion 13 of the lamp 10 to an edge of the light take-out region 21 further from the end portions 11a and 11b of the lamp 10, is 12.5 mm. FIG. 8 shows a relationship between lamp power and Dimension D3, the distance from the bent portion 13 to the edge of the light take-out region 21. As shown in FIG. 8, in the case where the dimensions of the envelope 20 are constant, as Dimension D3 is larger, the straight tube portions 14a and 14b of the lamp 10 become shorter, and accordingly the length of the lamp 10 becomes shorter. If the length of the lamp 10 is short, the lamp power decreases. Therefore, in terms of lamp power reduction, it is more effective as Dimension D3 is larger.

On the other hand, as Dimension D3 is larger, dark regions emitting no light within the light take-out region 21 increase. When the extent of the dark regions becomes excessively large, unevenness in luminance occurs since the translucent plate 60 cannot distribute it uniformly any more. In order not to cause unevenness in luminance, it is desirable to set Dimension D3 to 25 mm or less.

Furthermore, in terms of Dimension W of the space between the straight tube portions 14a and 14b of the lamp 10, it is desirable that Dimension D3 satisfy the following Equation 1. This realizes a well-balanced arrangement of the lamps 10, and accordingly light emitted from the lamps 10 can be uniformly diffused by the diffuser plate 61.

W/3≦D3≦W (Equation 1).

Note that it is further preferable to set W/3 to 2 mm or more since a reduction in lamp power can be achieved if Dimension D3 is 2 mm or more, as shown in FIG. 8.

Thus, it is preferable that Dimension D3, the distance from the bent portion 13 to the edge of the light take-out region 21, satisfy Equation 1 above. In addition, Dimension D6, the distance from the edge of the electrode 12 facing inward of the envelope 20 (i.e. a tip 12a of the electrode 12) to the edge of the bush 70 facing inward of the envelope 20 (i.e. the boundary of the light take-out region 21), is 3 mm, as described above. Therefore, in order to dispose the part of the lamp 10 having a relative luminance of less than 70% outside the light take-out region 21, it is desirable that the part between the tip 12a of the electrode 12 and less than 3 mm inward of the envelope 20 from the tip 12a be disposed outside the light take-out region 21. Therefore, if the following Equation 2 is satisfied, light emitted from the lamps 10 can be efficiently taken out from the light take-out opening of the envelope 20.

A−W+3≦L≦A−W/3+3 (Equation 2),

where A is the extent of the light take-out region 21 in the left-and-right direction, as described above, and L is the distance from the tip 12a of the electrode 12 to the edge 13a of the bent portion 13 in the left-and-right direction of the lamp 10 (i.e. the direction perpendicular to the direction in which the lamps 10 are laid in parallel to each other).

As shown in FIG. 6, Dimension D4, the distance between the straight tube portion 14a of one lamp 10 and the straight tube portion 14b of the adjacent lamp 10, is 22 mm which is substantially the same as Dimension W, the space between straight tube portions 14a and 14b of each lamp 10. That is to say, the lamps 10 are disposed in a manner that the tube axes of neighboring straight tube portions 14a and 14b are spaced at equal intervals, as shown in FIG. 2. As a result, unevenness in luminance is less likely to occur.

Note however that Dimension D4 does not have to be substantially the same as Dimension W, and unevenness in luminance can be sufficiently suppressed by the diffuser plate 61 if it is within the range of 0.8 to 1.2 times the Dimension W.

As shown in FIG. 2, Dimension D5, the space between the upper side member 41 of the side plate 40 and the closest straight tube portion 14a, is 11 mm. Dimension D7, the space between the loser side member 44 of the side plate 40 and the closest straight portion 14b, is also 11 mm. Thus, by setting Dimension D4 to 22 mm or less and Dimensions D5 and D7 to 11 mm or less, it is possible to make unevenness in luminance less likely to occur.

Supporting members 80 are vertically provided on the reflecting plate 30, as shown in FIG. 3. Three supporting members 80 are used to support each lamp 10 at the bent portion 13 and the straight tube portions 14a and 14b, as shown in FIG. 2. Note that the supporting members 80 for the bent portion 13 and for the straight tube portions 14a and 14b all have the same shape.

Each supporting member 80 is made of white PET resin, and has an engaging portion 81 with a C-shaped cross section at the top, as shown in FIG. 3. The inner diameter of the engaging portion 81 is rather smaller than the outer diameter of the lamp 10, and the lamp 10 is firmly held by the elasticity of the engaging portion 81.

On a part of the supporting member 80 which comes in contact with the lamp 10, i.e. the inner surface of the engaging portion 81, a heat insulating layer 82 and a reflection layer 83 are integrally formed in the stated order.

The heat insulting layer 82 is made of Teflon (registered trademark), and functions as a heat insulating agent between the lamp 10 and the supporting member 80. Note that the material of the heat insulating layer 82 is not limited to Teflon (registered trademark), and a material having a lower heat conductance than gas, i.e. air, filled in the envelope 20.

The heat of parts of the lamp 10 that are held by the supporting members 80 is transmitted to the envelope 20 via the supporting members 80. When the temperature of the parts held by the supporting members 80 decreases, these parts become the coldest spots, and consequently an adequate mercury vapor pressure cannot be achieved anymore. Therefore, the heat insulating layer 82 is provided to prevent a decrease in the temperature of the lamp 10.

The reflection layer 83 functions as a reflecting member for reflecting light of the lamp 10 towards the opening 51 of the mounting frame 50. In the backlight unit 1 of the present embodiment, since the bent portions 13 of the lamps 10 are disposed within the light take-out region 21, the bent portions 13 have to be supported within the light take-out region 21. Accordingly, in order to efficiently use light emitted from the bent portions 13, it is desirable to provide the reflection layer 83 to each supporting member 80. Note that the supporting members 80 are provided on the reflecting plate 30 side so as not to intercept light emitted toward the opening 51.

Since each of the lamps 10 is supported by the supporting members 80 at the bent portion 13 and the straight tube portions 14a and 14b, the backlight unit 1 allows positioning of the lamps 10 with high accuracy.

The present invention has been described based on the present embodiment; it is a matter of course, however, that the present invention is not limited to the embodiment. For example, the following cases are also within the scope of the present invention.

In the above embodiment, the lamps 10 are arranged in parallel to each other in a manner that the straight tube portions 14a and 14b are laid in the left-and-right direction. However, the present invention is not limited to this case, and the lamps 10 may be arranged in parallel to each other in a manner that the straight tube portions 14a and 14b are laid in the up-and-down direction.

In the above embodiment, the lamps are cold cathode fluorescent lamps. However, the present invention is not limited to this case, and external electrode fluorescent lamps, hot cathode fluorescent lamps, or lamps having no phosphor layer may be used instead.

### INDUSTRIAL APPLICABILITY

The backlight unit of the present invention is, for example, applicable to liquid crystal display apparatuses.

1. A backlight unit in which a plurality of substantially U-shaped lamps, each including two end portions and a bent portion, are disposed in parallel to one another in an envelope in a manner that the end portions of each of the lamps face opposite to the end portions of an adjacent one of the lamps and are positioned closer to a side wall of the envelope than the bent portion of the adjacent one of the lamps is, electrodes being respectively attached to each of the end portions, wherein
the bent portion of each of the lamps is positioned within a light take-out region of the envelope, and the end portions of each of the lamps are positioned outside the light take-out region, and
part of each of the lamps, which has a less than 70% relative luminance to the bent portion of each of the lamps, is positioned outside the take-out region.

2. (canceled)

3. The backlight unit of claim 1, wherein
the end portions and the electrodes of each of the lamps are housed in a socket positioned outside the light take-out region.

4. (canceled)

5. The backlight unit of claim 1, including:
a supporting member operable to support the lamps in the envelope, wherein
a reflection layer for reflecting light from the lamps toward a light take-out opening of the envelope is positioned at part of the supporting member, which is in contact with the lamps.

6.-9. (canceled)

10. The backlight unit of claim 1, wherein
W/3≦D3≦W is satisfied,
where D3 [m] is a distance from the bent portion of each of the lamps to an edge of the light take-out region further from the end portions of the each of the lamps, and W [mm] is a space between paired straight tube portions of the each of the lamps.

11. The backlight unit of claim 1, including:
a supporting member operable to support the lamps in the envelope, wherein
together with a heat insulating layer, a reflection layer for reflecting light from the lamps toward a light take-out opening of the envelope is positioned at part of the supporting member, which is in contact with the lamps, the heat insulating layer being between the reflection layer and the part of the supporting member.

12. The backlight unit of claim 1, wherein
bushes, each of which has a plurality of ribs on an outer circumference thereof and is made of an elastic material, are respectively attached to each of the end portions, and
the lamps are fixed by pressing each of the bushes in between clip-holding pieces on lateral sides of the envelope.

13. A substantially U-shaped lamp for a backlight unit, wherein
in the backlight unit, a plurality of substantially U-shaped lamps, each including two end portions and a bent portion, are disposed in parallel to one another in an envelope of the backlight unit in a manner that the end portions of each of the lamps face opposite to the end portions of an adjacent one of the lamps and are positioned closer to a side wall of the envelope than the bent portion of the adjacent one of the lamps is, an electrode being attached to each of the end portions, and
A−W+3≦L≦A−W/3+3 is satisfied, where A [mm] is an extent of a light take-out region of the backlight unit in a direction perpendicular to a direction in which the lamps are disposed in parallel to one another, W [mm] is a space between paired straight tube portions of each of the lamps, and L [mm] is a distance from a tip of the electrode to an edge of the bent portion in the perpendicular direction.
